(19) United States
(12) Patent Application Publication
(10) Pub. No.: US 2007/0013196 A1
(43) Pub. Date: Jan. 18, 2007

(54) Wind Power Generator

(76) Inventor: Shih H. Chen, Yongkang City (TW)

Correspondence Address: HDSL, 4331 STEVENS BATTLE LANE, FAIRFAX, VA, 22033, US

(21) Appl. No.: 11/428,354

(22) Filed: Jun. 30, 2006

(30) Foreign Application Priority Data
Jul. 14, 2005 (TW) 094211976

(51) Int. Cl. F03D 9/00; H02P 9/04

(52) U.S. Cl. 290/55

(57) ABSTRACT

A wind power generator includes a cover, a front nose cone, a rear nose cone and a vane unit. The cover has a curved air-guiding portion. The front nose cone and the rear nose cone have a plurality of supporting pillars fixedly connected to the front portion and rear portion of the inner wall of the cover, respectively. The vane unit is provided between the front nose cone and the rear nose cone. After the wind enters the passage formed between the curved surface of the front nose cone and the front portion of the curved air-guiding portion of the cover, the wind speed is accelerated due to the narrowing of the flowing path, thereby to generate a larger kinetic energy to cause the rotation of the vane unit. In this way, the generator within the rear nose cone obtains a greater capacity of generating electricity. Further, the generator can be still activated even under a lower wind speed.

### BACKGROUND OF THE INVENTION

1. Field of the Invention

The present invention relates to a wind power generator, and in particular to a wind power generator having a plurality of vanes.

2. Description of Prior Art

The conventional wind power generator disclosed in Taiwan Patent Publication No. M250048 utilizes the wind energy of the wind flow and converts the wind energy into the available electric energy. Such conventional wind power generator comprises a base, a structural frame provided upright on the base, a plurality of partitions provided in the structural frame for cooperating with the structural frame to define a plurality of comb-like wind-collecting partitions, each wind-collecting partition having a windward port for the entrance of the wind flow and a leeward port for the exhaust of the wind flow, and a plurality of windward vane wheels correspondingly provided in the plurality of wind-collecting partitions. Each windward vane wheel includes a hub and a plurality of windward vanes radially provided on the circumference of the hub. The plurality of windward vanes can be pushed by the wind flow flowing into the corresponding wind-collecting partitions. In this way, the wind energy in the wind flow can be utilized and thus converted into the mechanical energy. A power-generating unit connected to the plurality of windward vane wheels is used to receive the mechanical energy transmitted by the plurality of windward vane wheels and thus to be driven to generate the electricity.

Although the above conventional wind power generator can generate the electricity by driving the power-generating unit connected to the plurality of vane wheels, in use, the wind power generator uses the windward ports and the leeward ports of the wind-collecting partitions to allow the wind to flow in or flow out, thereby to cause the rotation of the windward vanes of the vane wheels. However, since in the base of the wind power generator, only the structural frame cooperates with the plurality of partitions to define a plurality of comb-like wind-collecting partitions, and the periphery of the wind-collecting partition defined by the a plurality of partitions is a flat plate. Therefore, when the wind flows in the wind-collecting partitions, it flows through each wind-collecting partition smoothly, and thus the rotation of the vanes is restricted by the strength of the wind force. That is, if the wind force is larger, the rotation speed becomes higher accordingly. If the wind force is smaller, the rotation speed becomes lower accordingly. Therefore, a compressed wind force cannot be obtained between each wind-collecting partition, and it is impossible to obtain a stronger wind pressure with a smaller wind force, which causes the windward vanes cannot provide the electricity with a stable rotation speed. Further, since the whole structure and the volume of the vane wheels are bulky, the windward vanes of the vane wheels should be driven by a wind with a certain wind speed. If the wind speed is too low to drive the windward vanes or the windward vanes rotate too slowly, the wind power generator cannot stably generate the desired electric power.

In view of the above, the inventor proposes the present invention to overcome the above problems based on his expert experiences and deliberate researches.

### SUMMARY OF THE INVENTION

The present invention is to solve the above problems. To avoid the problems, in the present invention, the wind power generator is re-designed to have a plurality of vanes therein. With this arrangement, the efficient windward area is increased, so that the driving force becomes larger and thus a larger amount of electricity can be generated.

The present invention is directed to an improved wind power generator, which comprises a cover, a front nose cone, a rear nose cone and a vane unit. When the wind enters the passage formed between the curved surface of the front nose cone and the front portion of the curved air-guiding portion of the cover, the wind speed is accelerated due to the narrowing of the flowing path, thereby to generate a larger kinetic energy to cause the rotation of the vane unit. In this way, the generator within the rear nose cone obtains a greater capacity of generating electricity. Further, the generator can be still activated even under a lower wind speed.

### BRIEF DESCRIPTION OF THE DRAWINGS

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 is a perspective view showing the external appearance of the present invention;

FIG. 2 is a cross-sectional view of the present invention;

FIG. 3 is a front view showing the operating state of the present invention; and

FIG. 4 is a cross-sectional view showing the operating state of the present invention.

### DETAILED DESCRIPTION OF THE INVENTION

The technical contents and the detailed description of the present invention will be made with reference to the accompanying drawings.

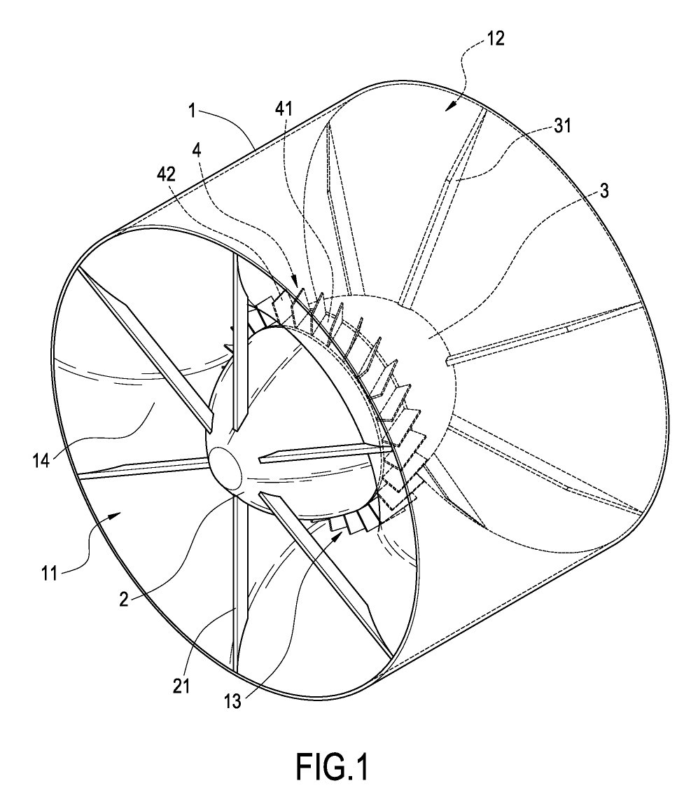

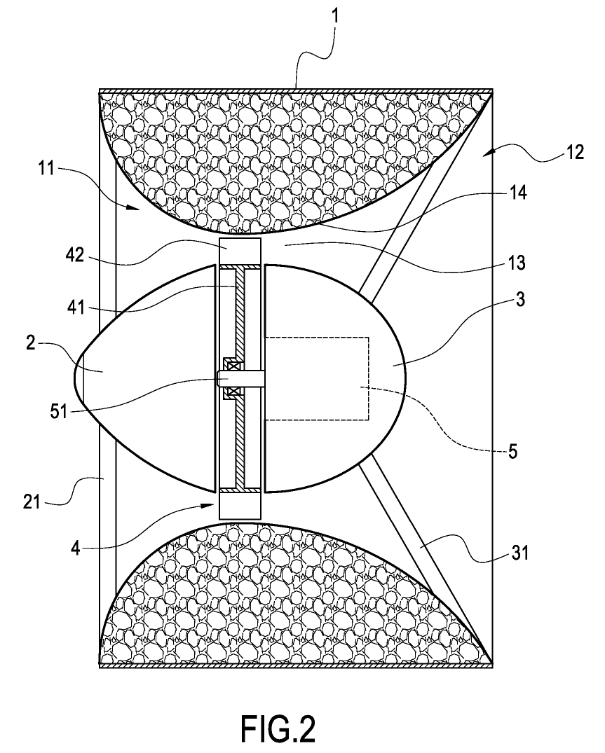

FIG. 1 is a perspective view showing the external appearance of the present invention, and FIG. 2 is a cross-sectional view of the present invention. As shown in the drawings, the present invention is directed to an improved wind power generator comprising a cover 1, a front nose cone 2, a rear nose cone 3 and a vane unit 4. The cover 1 is used to cooperate with the front nose cone 2 and the rear nose cone 3 to increase the efficient windward area. The airflow can be accelerated when passing through the narrowed flowing path, thereby to also increase the kinetic energy. In this way, the vane unit 4 can generate a larger kinetic energy and thus to obtain a greater capacity for generating electricity.

The cover 1 has a curved air-guiding portion 14 therein. The curved air-guiding portion 14 makes both ends of the cover 1 to form widening portions 11, 12 and makes the center of the cover to form a narrowed flowing path 13. The cover 1 is constituted of a plurality of plates. Each plate can be formed by any one of the manners of welding, pivoting, fastening or bending a single plate, thereby to form a polygonal cover. Alternatively, the cover 1 can be formed into a circular shape. Further, the curved air-guiding portion 14 can be made of light-weighted materials, such as any one of foamed materials, Styrofoam, glass fiber or carbon fiber.

The periphery of the front nose cone 2 has a plurality of supporting posts 21 fixedly connected to the inner wall of the cover 1, so that the front nose cone 2 can be fixedly provided in the widening portion 11 of the cover 1. Thus, a narrowed passage is formed between the curved surface of the front nose cone 2 and the front portion of the curved air-guiding portion 14, thereby to facilitate the airflow to blow to the vane unit 4.

The periphery of the rear nose cone 3 has a plurality of supporting posts 31 fixedly connected to the inner wall of the cover 1, so that the rear nose cone 3 can be fixedly provided in the widening portion 12 of the cover 1. Thus, a passage is formed between the curved surface of the rear nose cone 3 and the rear portion of the curved air-guiding portion 14. In this way, after the airflow flows through the vane unit 4, the pressure of the airflow can be increased to the outside atmospheric pressure when it flows through the outlet of the widening portion 12, thereby to increase the output driving force of the vane unit 4 to generate a greater electricity.

The vane unit 4 is provided between the front nose cone 2 and the rear nose cone 3 with a vane frame 41 thereon. The vane frame 41 is fixedly connected to a rotating shaft 51 of the generator 5 within the rear nose cone 3. Further, the vane frame 41 is circumferentially provided with a plurality of vanes 42 thereon.

With the provision of the plurality of vanes, the efficient windward area can be increased, thereby to accelerate the wind speed. Therefore, the larger kinetic energy can be obtained to generate greater amount of electricity.

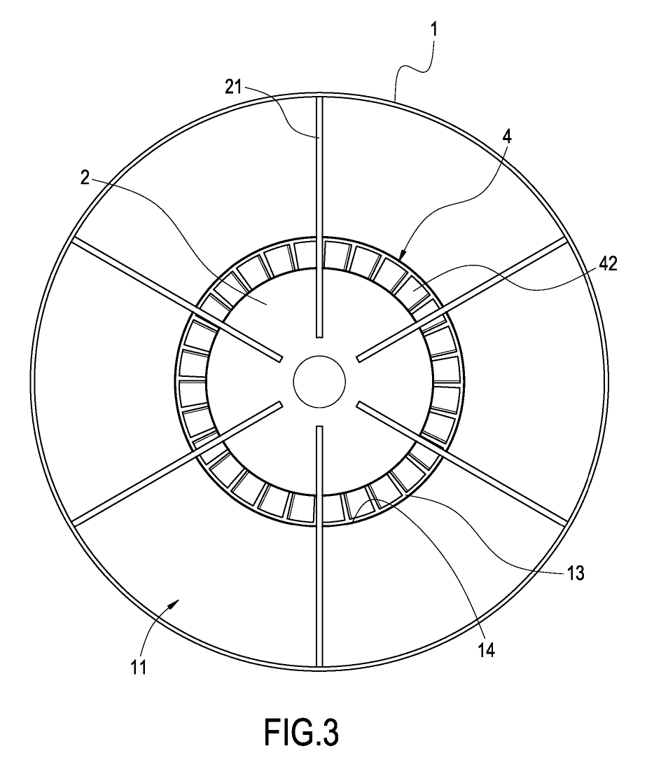

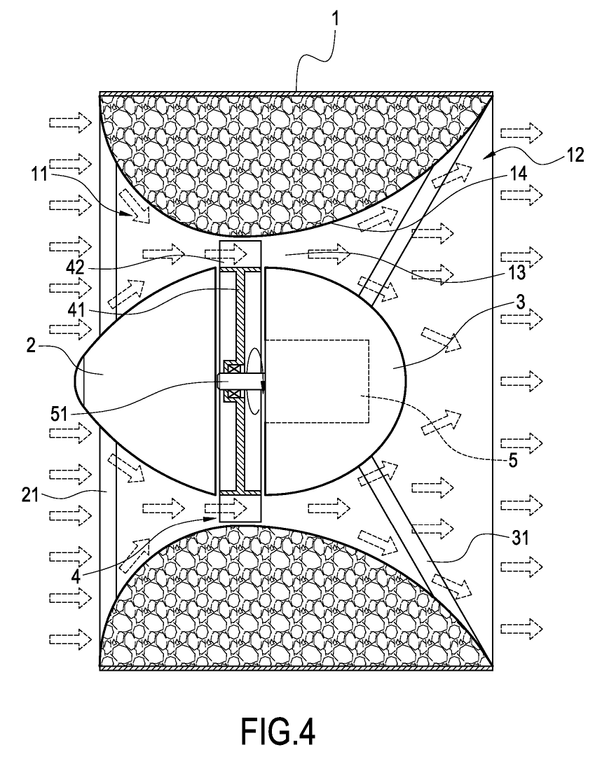

FIG. 3 is a front view showing the operating state of the present invention, and FIG. 4 is a cross-sectional view showing the operating state of the present invention. During the operation of the present invention, the cover 1 can be fixedly provided at a predetermined position according to the desired position for generating the electricity by wind power. When the wind blows in from the front, the wind enters the widening portion 11 of the cover 1 and the front nose cone 2 while the efficient windward area is increased. When the wind enters the narrowed passage formed between the curved surface of the front nose cone 2 and the front portion of the curved air-guiding portion 14, the airflow can be accelerated to generate a larger kinetic energy to cause the rotation of the vanes 42. Thus, the generator 5 obtains a greater capacity for generating the electricity.

According to the above, the present invention has the advantages as follows.

1. The narrow passage formed between the curved surface of the front nose cone 2 and the front portion of the curved air-guiding portion 14 can accelerate the airflow, which produce a greater driving force to the vanes 42 of the vane unit 4. Therefore, the generator 5 can be still activated even the outside wind speed is low. Further, under the same outside wind speed, the present invention generates a greater amount of electricity.

2. The airflow is guided by the smooth curve of the front nose cone 2, so that the flowing field of the vanes 42 is smoother, thereby to increase the efficiency in the kinetic energy of the vane unit 4.

3. The cover helps to reduce the noise.

4. The whole structure is simple, easy to manufacture and low in cost.

5. Only smaller wind power is necessary to generate the electricity, so that the present invention is suitable for the families, factories and communities.

6. The present invention can be provided in remote districts or some places where the lines for delivering the electricity are difficult to build.

7. It can be applied to a small generator, thereby to achieve a low unit price, low technical level, great driving force and capacity of generating the electricity.

Although the present invention has been described with reference to the foregoing preferred embodiment, it will be understood that the invention is not limited to the details thereof. Various equivalent variations and modifications can still be occurred to those skilled in this art in view of the teachings of the present invention. Thus, all such variations and equivalent modifications are also embraced within the scope of the invention as defined in the appended claims.

What is claimed is:

1. A wind power generator, comprising:
a cover having a curved air-guiding portion therein, the curved air-guiding portion formed with widening portions at both ends of the cover and a narrowed flowing path in the center thereof;
a front nose cone having a curved surface, the curved surface having a plurality of first supporting posts fixedly connected to the inner wall of the cover, the front nose cone and the front portion of the curved air-guiding portion formed to correspond with each other;
a rear nose cone having a curved surface, the curved surface having a plurality of second supporting posts fixedly connected to the inner wall of the cover, the rear nose cone and the rear portion of the curved air-guiding portion formed to correspond with each other; and
a vane unit provided between the front nose cone and the rear nose cone.

2. The wind power generator according to claim 1, wherein the cover includes a plurality of plates, and each plate is formed by any one of welding, pivoting, fastening or bending a single plate.

3. The wind power generator according to claim 1, wherein the cover is formed into a circular shape.

4. The wind power generator according to claim 1, wherein the curved air-guiding portion is made of light-weighted materials.

5. The wind power generator according to claim 4, wherein the light-weighted material is any one of foamed material, Styrofoam, glass fiber or carbon fiber

6. The wind power generator according to claim 1, wherein the rear nose cone is provided with a generator therein, and the generator has a rotating shaft extending to the outside of the rear nose cone.

7. The wind power generator according to claim 1, wherein the vane unit comprises a vane frame fixedly connected to the rotating shaft of the generator, and the vane frame is circumferentially provided with a plurality of vanes.
